(19) United States
(12) Patent Application Publication
(10) Pub. No.: US 2026/0147929 A1
(43) Pub. Date: May 28, 2026

(54) SELECTIVE ANONYMIZATION WITH INTELLIGENT MASKING FOR USER DATA

(71) Applicant: SAP SE, Walldorf (DE)

(72) Inventors: Sudhakar SINGH, Bangalore (IN); Kshitij Rajesh RAO, Thane (IN)

(21) Appl. No.: 19/181,581

(22) Filed: Apr. 17, 2025

Related U.S. Application Data
(63) Continuation-in-part of application No. 18/898,206, filed on Sep. 26, 2024.
(60) Provisional application No. 63/781,008, filed on Mar. 31, 2025.

(51) Int. Cl. G06F 21/62

(52) U.S. Cl. CPC G06F 21/6254; G06F 21/6227

(57) ABSTRACT

Disclosed herein are various embodiments for selectively anonymizing user data with intelligent masking. An embodiment operates by receiving a user query to be executed by a first large language model (LLM) external to a computing system. Phrases within the user query that include user data based are identified based on a correspondence to one or more entities from an anonymization template. Masked queries are generated based on the user query, and executed by a second LLM. The second LLM generates both a first output from executing the user query, and a second output from executing a first masked query of the one or more masked queries. A similarity score is calculated between the first output and the second output, and it is determined that the similarity score exceeds a threshold. A revised user query including a masking of the first phrase is generated and executed by the first LLM.

### CROSS-REFERENCE TO RELATED APPLICATIONS

This application is a continuation-in-part of U.S. patent application Ser. No. 18/898,206, titled “Selective Anonymization For User Data,” filed Sep. 26, 2024, and this application also claims priority to U.S. Provisional Application 63/781,008, titled “Selective Anonymization With Intelligent Masking For User Data,” filed Mar. 31, 2025, both of which are hereby incorporated by reference in their entireties.

### BACKGROUND

In recent years, there has been an increase in demand for the use of language models, as typified by Large Language Models (LLMs), in business applications. At the same time, there is a technical issue of how to prevent LLMs from accessing sensitive data contained in business data. Additionally, there is the technical challenge of preventing LLMs from accessing sensitive business data while still preserving the context of the original business data.

### BRIEF DESCRIPTION OF THE DRAWINGS

The accompanying drawings are incorporated herein and form a part of the specification.

FIG. 1 is an architecture of a system for selective anonymization, according to some embodiments.

FIG. 2 is a UI (User Interface) of a system for selective anonymization, according to some embodiments.

FIG. 3 is a flowchart for a method for creating an anonymization template, according to some embodiments.

FIG. 4 is an architecture of an anonymization backend system, according to some embodiments.

FIG. 5 is a workflow of a method for selective anonymization, according to some embodiments.

FIG. 6 is a flowchart for a method for selective anonymization, according to some embodiments.

FIG. 7 is an example computer system useful for implementing various embodiments.

FIG. 8 is a block diagram illustrating an example selective anonymization system (SAS) with intelligent masking, according to some embodiments.

FIG. 9 is an example user interface through which a user may communicate with SAS, according to some embodiments.

FIG. 10 is a flowchart illustrating example operations for providing an selective anonymization system (SAS) with intelligent masking, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method, and/or computer program product embodiments, and/or combinations and sub-combinations thereof, for selective anonymization.

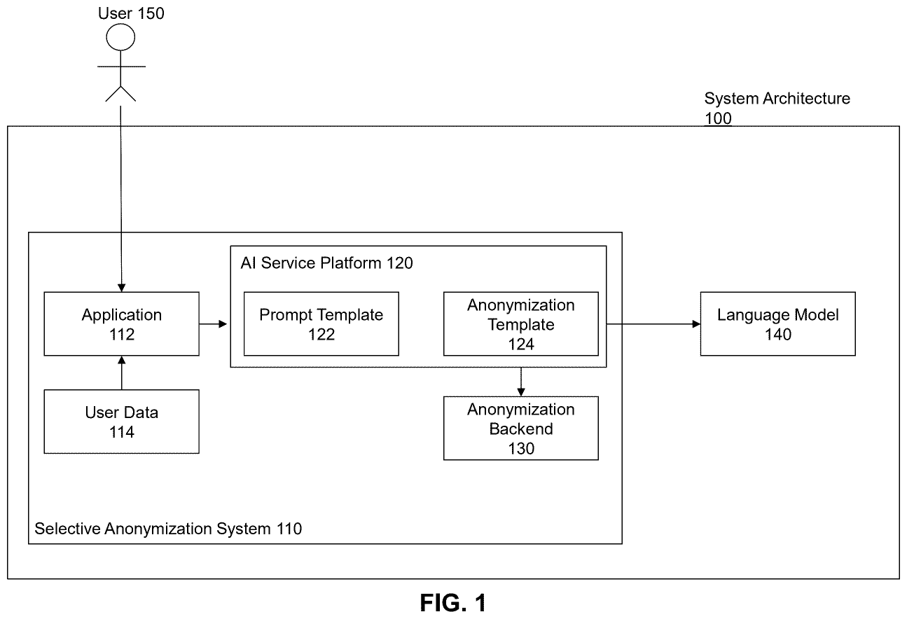

FIG. 1 is an architecture of a system for selective anonymization, according to some embodiments. System architecture 100 may include selective anonymization system 110 and language model 140. Selective anonymization system 110 may be a system provided for user 150. Selective anonymization system 110 may interact with user 150 and anonymize user data which may be sent to language model 140.

Selective anonymization system 110 may include application 112. Application 112 may provide a UI (User Interface) to user 150 and selectively anonymize data in cooperation with other data sources, microservices, and applications.

User data 114 may include first data (e.g., business data provided by user 150), and a first prompt indicates how to process the first data. User data 114 may contain PII (Personally Identifiable Information) or confidential data. Selective anonymization system 110 may selectively anonymize the PII and the confidential data while maintaining the context of the first data or first prompt in user data 114.

AI (Artificial Intelligence) service platform 120 may function as a hub that mediates the transfer of data between the AI, such as language model 140, within system architecture 100. Prompt template 122 may indicate that data provided to language model 140 is anonymized so that language model 140 can process the data properly.

Anonymization template 124 may specify a profile included in user data 114. The profile may be anonymized by selective anonymization system 110. The profile may be a name, an email address, a residence, an entity name, a phone number, a social security number, or any other PII or confidential information. Anonymization template 124 may also specify a tool used for the anonymization. The tool may be a model including an LLM or SLM (Small Language Model), or tools that do not use a language model (e.g., a rule-based anonymization tool).

Anonymization backend 130 may perform the processing required for selective anonymization, and provide the anonymized data to language model 140. Details of anonymization backend 130 are described below.

As such, user data 114 provided by user 150 may be selectively anonymized by selective anonymization system 110 and processed appropriately by language model 140.

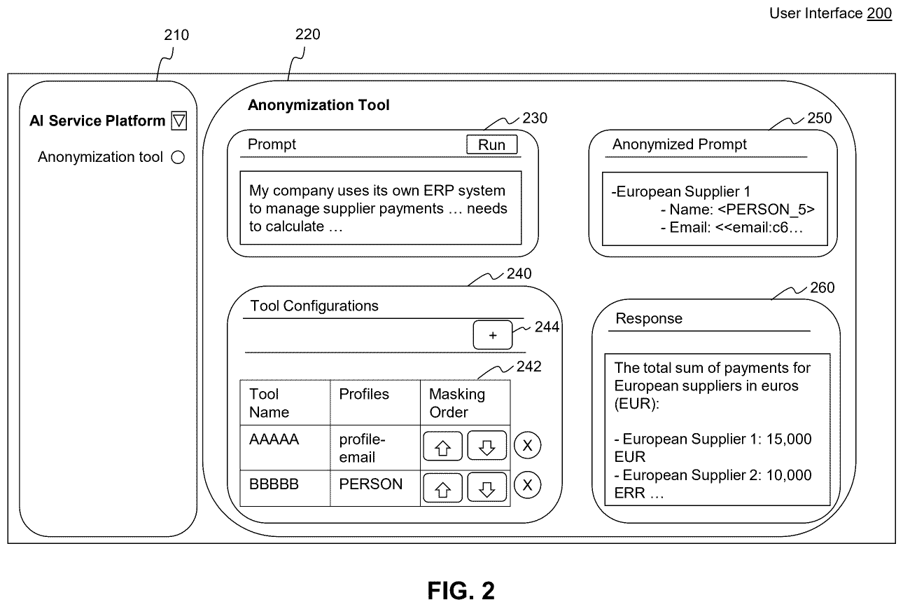

FIG. 2 is a UI of a system for selective anonymization, according to some embodiments. User interface 200 may be a user interface of application 112. User interface 200 may display menu window 210 and tool window 220. Menu window 210 may show tools implemented in AI service platform 120. FIG. 2 shows the case where the anonymization tool performing the selective anonymization is selected by user 150.

Tool window 220 may display windows used for inputting and outputting the information for selective anonymization. Tool window 220 may include prompt window 230, tool configuration window 240, anonymized prompt window 250, and response window 260.

Prompt window 230 may receive the first prompt from user 150. As explained above, the first prompt may indicate how to process the first data. For example, the first prompt may include a following instruction to language model 140:
“My company uses its own ERP system to manage supplier payments. The company deals with suppliers from both Europe and India, and it needs to make monthly payments to these suppliers in their respective currencies: euros (EUR) for European suppliers and rupees (INR) for Indian suppliers. The finance department at the company needs to calculate the total sum of payments in both currencies for budgeting and financial reporting purposes.”

Prompt window 230 also may receive the first data from user 150. For example, the first data may include the following business data:
“Supplier Payments Data in ERP:
European Suppliers:
   European Supplier 1
      Name: John Smith
      Email: john.smith@eurosupplier.com
      Payment Amount: 15,000 EUR
   European Supplier 2
      Name: Maria Garcia
      Email: maria.garcia@eurosupplier.com
      Payment Amount: 10,000 EUR
   European Supplier 3
      Name: Andreas Müller
      Email: andreas.mueller@eurosupplier.com
      Payment Amount: 5,000 EUR
Indian Suppliers:
   Indian Supplier 1
      Name: Rajesh Patel
      Email: rajesh.patel@indiasupplier.com
      Payment Amount: 1,200,000 INR
   Indian Supplier 2
      Name: Priya Singh
      Email: priya.singh@indiasupplier.com
      Payment Amount: 800,000 INR
   Indian Supplier 3
      Name: Sunil Kumar
      Email: sunil.kumar@indiasupplier.com
      Payment Amount: 500,000 INR”

User 150 can input the user data 114 into the selective anonymization system 110 in various other ways. For example, user 150 may also upload a file including the first prompt or the first data to selective anonymization system 110 directly. The first prompt may also specify how to receive the first data from other systems connected to selective anonymization system 110. In addition, the first prompt and the first data may not be clearly separated data, and the first data may be included in the first prompt.

Tool configuration window 240 may display anonymization template 124 via anonymization template table 242. As explained above, anonymization template 124 may specify the profile included in user data 114 and the tool used for the anonymization. For example, anonymization template table 242 indicates that a tool “AAAAA” is used for anonymizing a profile “profile-email” and then, a tool “BBBBB” is used for anonymizing a profile “PERSON.” The order in which the tools are applied can be changed in the “masking order” table. User 150 may add a tool by pressing a “+ button”. How user 150 creates the anonymization template 124 is described below. By applying multiple tools to the profiles in a layer format as shown in tool configuration window 240, anonymization can be carried out by using the best tools for the selected profiles.

Anonymized prompt window 250 may display anonymized user data. As explained above, the profiles in user data 114 are anonymized by tools specified in anonymization template 124. Here, the first data includes suppliers' email addresses as the “profile-email” profile and suppliers' names as the “PERSON” profile. Then, the suppliers' emails are anonymized by the tool “AAAAA,” and the suppliers' email addresses are anonymized by the tool “BBBBB.” For example, the anonymized user data may include the following anonymized first data:
“Supplier Payments Data in ERP:
European Suppliers:
   European Supplier 1
      Name: <PERSON_5>
      Email: <email>: 3792a108-4f1a-429a-b94f-3b2e4bafebb4
      Payment Amount: 15,000 EUR
   European Supplier 2
      Name: <PERSON_4>
      Email: <email>: 38727696-9a4e-47ea-bdc3-7e3ca2adf6f1
      Payment Amount: 10,000 EUR
   European Supplier 3
      Name: <PERSON_3>
      Email: <email>: d0c23c68-8466-41a7-a535-ccd872f58eaf
      Payment Amount: 5,000 EUR
Indian Suppliers:
   Indian Supplier 1
      Name: <PERSON_2>
      Email: <email>: c197ce41-6953-4574-b150-b2d88892eba0
      Payment Amount: 1,200,000 INR
   Indian Supplier 2
      Name: <PERSON_1>
      Email: <email>: 18003571-4cd7-4e5c-b7bbede2e0450b9e
      Payment Amount: 800,000 INR
   Indian Supplier 3
      Name: <PERSON_0>
      Email: <email>: 2e38145d-5441-4bd2-8e47-05e08ded3398
      Payment Amount: 500,000 INR”

As shown in the anonymized first data above, anonymizing the profile may be performed by replacing the profile with a tag structure using “< >.” The tag structure may be useful as a clue to help language model 140 for determining which parts are anonymized. In the example above, the first prompt does not include the profile, but if the first prompt includes the profile, anonymization may be performed in the same way.

Response window 260 may display a de-anonymized response from language model 140. As explained above, language model 140 may process the anonymized user data. In the example above, language model 140 may process the anonymized first data shown above based on the instruction described in the first prompt shown above and prompt template 122.

As explained above, prompt template 122 may indicate that data provided to language model 140 is anonymized so that language model 140 can process the data properly. For example, prompt template 122 may include the following messages:

```
“messages = [
  {
    “role” : “system”,
    “content” : “““ You are a large language model. Understand and respond to
  the user's queries accurately. Any text wrapped within ‘<>’ should be treated as
  masked personally identifiable information (PII) and should be maintained as it is in
  the response. Do not attempt to unmask or make assumptions about the information
  inside the tags. ”””
  },
  {
    “role” : “user”,
    “content” : user-text
  }
]
```

As shown in the message above, the prompt may instruct language model 140 to maintain the tag structure in the anonymized response. In this way, the tag structure is maintained within the responses of language model 140, making a de-anonymization process described below easier.

The result of de-anonymized response of the language model 140 based on the anonymized first data, the instruction described in the first prompt, and prompt template 122 may be as follows:
“The total sum of payments to European suppliers in euros (EUR) is:
15,000 (European Supplier 1)+10,000 (European Supplier 2)+5,000 (European Supplier 3)=30,000 EUR
The total sum of payments to Indian suppliers in rupees (INR) is:
1,200,000 (Indian Supplier 1)+800,000 (Indian Supplier 2)+500,000 (Indian Supplier 3)=2,500,000 INR.”

In this way, user 150 can selectively anonymize user data 114 on user interface 200 and have language model 140 process the anonymized user data.

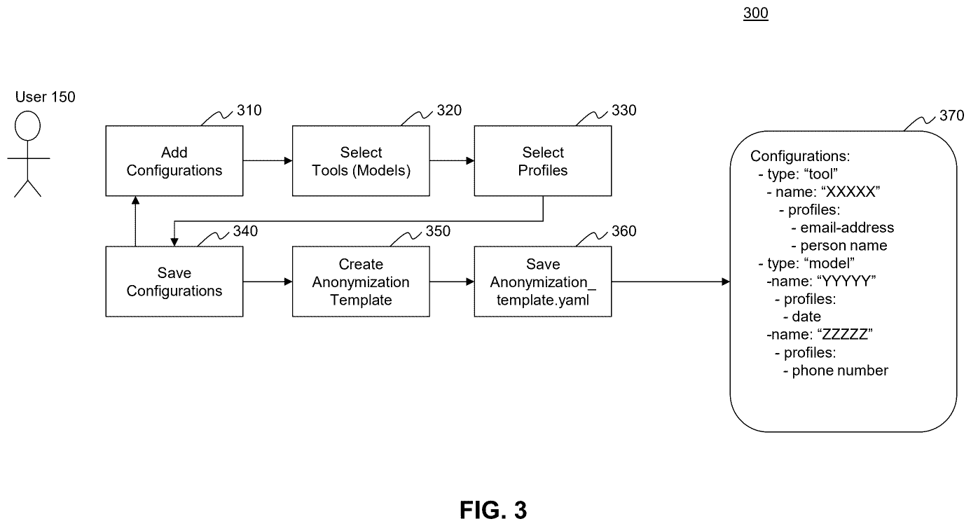

FIG. 3 is a flowchart for a method 300 for creating an anonymization template, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIGS. 1 and 2. However, method 300 is not limited to that example embodiment.

As explained above, selective anonymization system 110 can edit anonymization template 124 via user interface 200. Method 300 illustrates exemplary creation flow of anonymization template 124.

In 310, selective anonymization system 110 may receive a configuration which is a combination of the tool name and the profile. For example, user 150 can add the configuration by pressing add button 244.

In 320, selective anonymization system 110 may receive a selection of a tool for the anonymization. As explained above, the tool may be a model including an LLM or SLM, or tools that do not use a language model (e.g., a rule-based anonymization tool). The selection may include a predetermined profile or a custom profile.

In 330, selective anonymization system 110 may receive a selection of a profile to be anonymized by the tool. As explained above, the profile be a name, an email address, a residence, an entity name, a phone number, a social security number, or any other PII or confidential information.

In 340, selective anonymization system 110 may save the configuration. The saving operation may be performed via user interface 200. If selective anonymization system 110 proceeds to add the configuration further after saving the configuration, selective anonymization system 110 may repeat the process from operation 310.

In 350, selective anonymization system 110 may create anonymization template 124 based on the configuration.

In 360, selective anonymization system 110 may save anonymization template 124 as a “yaml” file format. For example, anonymization template file 370 has the “yaml” file format and indicates that the tool XXXXX (note that the term “tool” here is used to distinguish it from the term “model”, which refers to a language model) is used to anonymize the profiles of “email address” and “person name”, the tool “YYYYY” is used to anonymize the profile of “date”, and the tool “ZZZZZ” is used to anonymize the profile of “phone number.” The saving process may allow selective anonymization system 110 to create multiple anonymization templates and store the anonymization templates so that the anonymization template 124 can serve different use-case or scenarios.

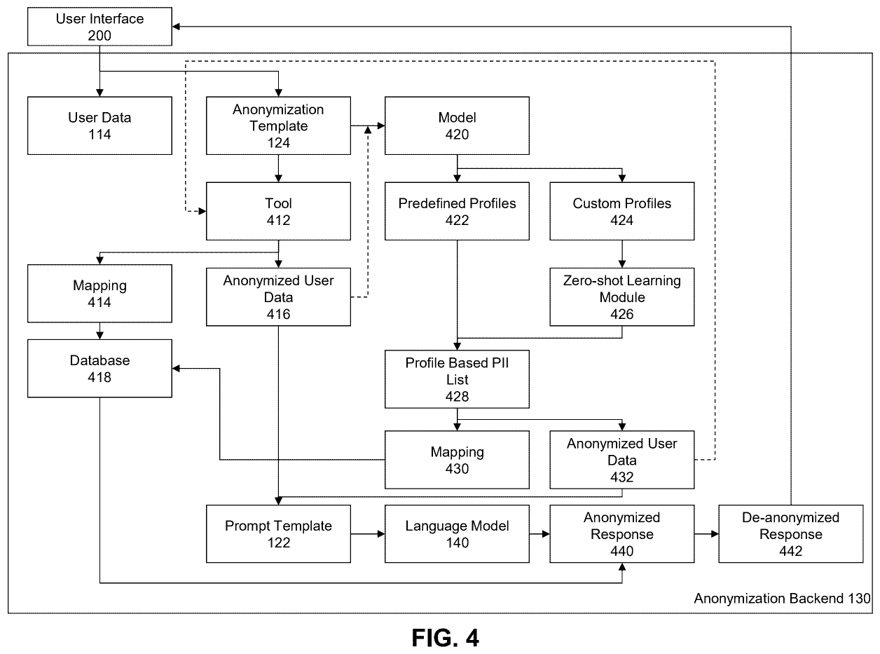

FIG. 4 is an architecture of an anonymization backend, according to some embodiments. The processing flow explained above is explained from the perspective of architecture below, and some parts are explained in more detail.

Anonymization backend 130 may receive, via user interface, user data 114 and anonymization template 124. Anonymization template 124 may specify either a narrow-sense tool 412, which is a tool other than a language model, or a model 420, which is a language model as a tool.

User data 432 may be anonymized by tool 412 or by model 420. Tool 412 may create mapping 414 and anonymized user data 416. Mapping 414 may indicate a mapping between the anonymized profile and the tag structure. For example, mapping 414 may indicate that the “<PERSON_5>” in anonymized user data 416 corresponds to “John Smith” in user data 114. Mapping 414 may be saved in database 418. The tag structure may have <Profile name—n> structure where n is a number that will be used to distinguish different PII that fall under the same profiles.

Model 420 may anonymize user data 114 or further iteratively anonymize anonymized user data 416. If the profile specified in anonymization template 124 is predefined profile 422, model 420 may anonymize predefined profile 422 and create profile based PII list 428. Profile based PII list 428 may indicate a list of PII anonymized by model 420. Profile based PII list may be used for creating a mapping 430 and anonymized user data 432.

If the profile specified in anonymization template 124 is custom profile 424, zero-shot learning module 426 may perform a zero-shot learning to user data 114 to identify which profiles to be anonymized. After identifying the profile, model 420 may anonymize user data 114 or anonymized user data 416 and may create mapping 430 and anonymized user data 432. As such, zero-shot learning module 426 can simplify the process of adding new custom profiles.

Language model 140 may iteratively process anonymized first data in anonymized user data 416 or anonymized user data 432 according to anonymized first prompt in anonymized user data 416 or anonymized user data 432, and prompt template 122. Language model 140 may transmit anonymized response 440 as a result of the anonymization.

Anonymization backend 130 may de-anonymize the received anonymized response 440 and create de-anonymized response 442. Anonymization backend 130 may use mapping 414 or mapping 430 store in database 418 for the de-anonymization. For example, anonymization backend 130 may replace the anonymized profile with the profile (e.g., a name, an email address, a residence, an entity name, a phone number, a social security number, or any other PII or confidential information) by using the mapping between the anonymized profile and the tag structure. User interface 200 may display de-anonymized response 442 on response window 260.

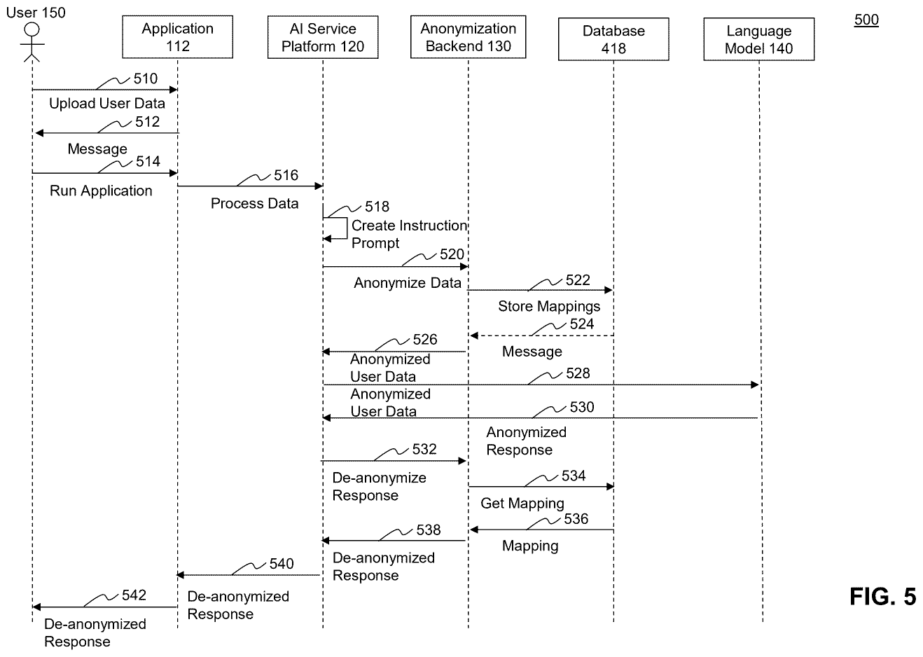

FIG. 5 is a workflow of a method 500 for selective anonymization, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 500 shall be described with reference to FIGS. 1-4. However, method 500 is not limited to that example embodiment.

In 510, selective anonymization system 110 may receive user data 114 to application 112. For example, selective anonymization system 110 may receive user data 114 via prompt window 230.

In 512, application 112 may transmit a message to user 150. For example, application 112 may transmit the message saying “user data uploaded successfully.”

In 514, selective anonymization system 110 may run application 112. For example, selective anonymization system 110 may run application 112 in response to pressing the run button in prompt window 230.

In 516, application 112 may instruct AI service platform 120 to process data. For example, application 112 may transmit, to AI service platform 120, user data 114, an anonymization template id that specifies anonymization template 124, and prompt template id which specifies prompt template 122 with the instruction.

In 518, AI service platform 120 may create an instruction prompt. The instruction prompt may be created based on the first data and the first prompt in user data 114.

In 520, AI service platform 120 may instruct anonymization backend 130 to anonymize user data 114. For example, AI service platform 120 may transmit, to anonymization backend 130, the instruction prompt and anonymization template 124 with the instruction for anonymizing user data 114.

In 522, anonymization backend 130 may anonymize user data 114 and store mapping 414 or 430 to database 418. For example, anonymization backend 130 may store mapping 414 or 430 with an anonymization ID, which is a unique ID for the anonymization.

In 524, database 418 may transmit a message to anonymization backend 130. For example, database 418 may transmit a message saying “mapping stored successfully.”

In 526, anonymization backend 130 may transmit anonymized user data 416 (e.g., with the instruction prompt) or 432 to AI service platform 120. For example, anonymization backend 130 may transmit anonymized user data 416 or 432 with the anonymization ID to AI service platform 120.

In 528, AI service platform may transmit anonymized user data 416 or 432 with prompt template 122 or the instruction prompt to language model 140.

In 530, language model 140 may transmit anonymized response 440 to AI service platform 120.

In 532, AI service platform 120 may instruct anonymization backend 130 to de-anonymize the received anonymized response 440. For example, AI service platform 120 may transmit anonymized response 440 with the anonymization ID to anonymization backend 130.

In 534, anonymization backend 130 may obtain mapping 414 or 430 from database 418 for the de-anonymization. For example, anonymization backend 130 may request mapping 414 or 430 with the anonymization ID.

In 536, database 418 may transmit mapping 414 or 430 to anonymization backend 130.

In 538, anonymization backend 130 may de-anonymize the received anonymized response 440 and transmit de-anonymized response 442 to AI service platform 120.

In 540, AI service platform 120 may transmit de-anonymized response 442 to application 112.

In 542, application 112 may display de-anonymized response 442 to user 150. For example, application 112 may display de-anonymized response 442 in response window 260.

As such, selective anonymization system 110 can selectively anonymize and retain user data 114's context. Thus, selective anonymization can ensure that anonymized user data 416 remains useful for being processed by language model 140.

Further, user 150 can have decision power over which profiles be anonymized using specific tools. Therefore, user 150 can keep some PII visible for processing by the language model 140 as needed.

In addition, once anonymization template 124 is created, it can be reused for similar use cases or scenarios. User 150 can also publish anonymization template 124 for other users to apply to their use cases or scenarios.

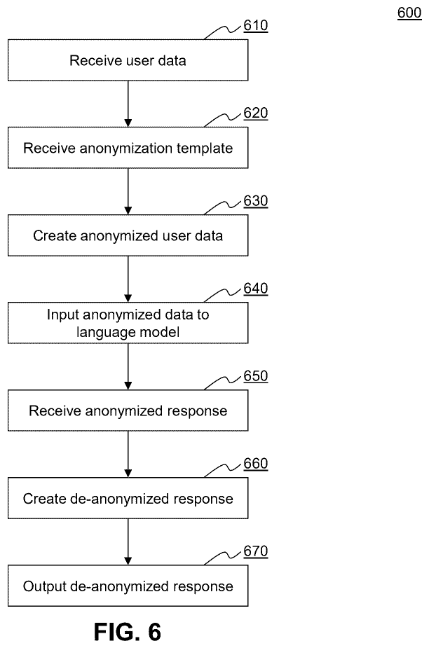

FIG. 6 is a flowchart for a method 600 for selective anonymization, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art. Method 600 shall be described with reference to FIGS. 1-5. However, method 600 is not limited to that example embodiment.

In 610, selective anonymization system 110 may receive user data 114. User data 114 may include a first data and a first prompt, and the first prompt may indicate how to process the first data.

In 620, selective anonymization system 110 may receive anonymization template 124. Anonymization template 124 may specify a profile to be anonymized in the user data 114 and tool 412 used for anonymization.

In 630, selective anonymization system 110 may create anonymized user data 432. Anonymized user data 432 may be iteratively anonymized by anonymizing the profile in user data 114 using tool 412 specified in anonymization template 124.

In 640, selective anonymization system 110 may input anonymized user data 432 to language model 140.

In 650, selective anonymization system 110 may receive anonymized response 440. Anonymized response 440 is a result of language model 140 processing anonymized user data 432.

In 660, selective anonymization system 110 may create de-anonymized response 442.

In 670, selective anonymization system 110 may output de-anonymized response 442.

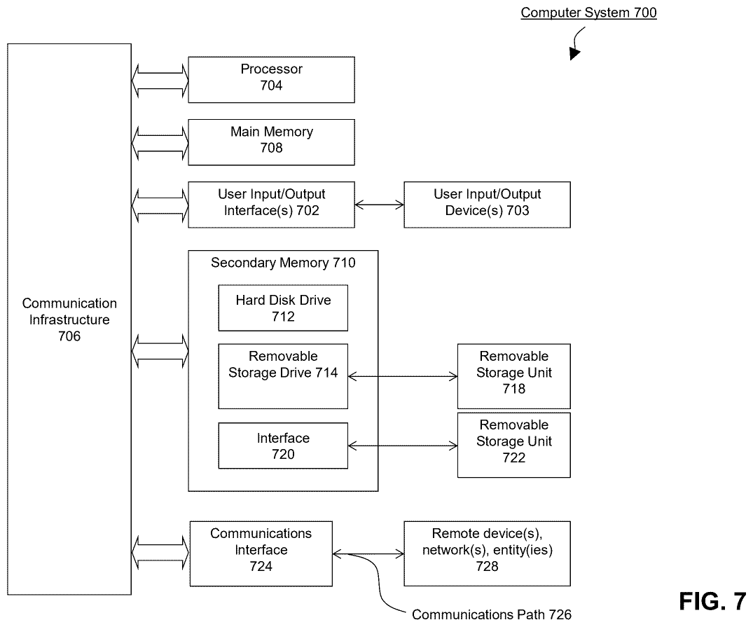

FIG. 7 is an example computer system useful for implementing various embodiments. Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). A GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

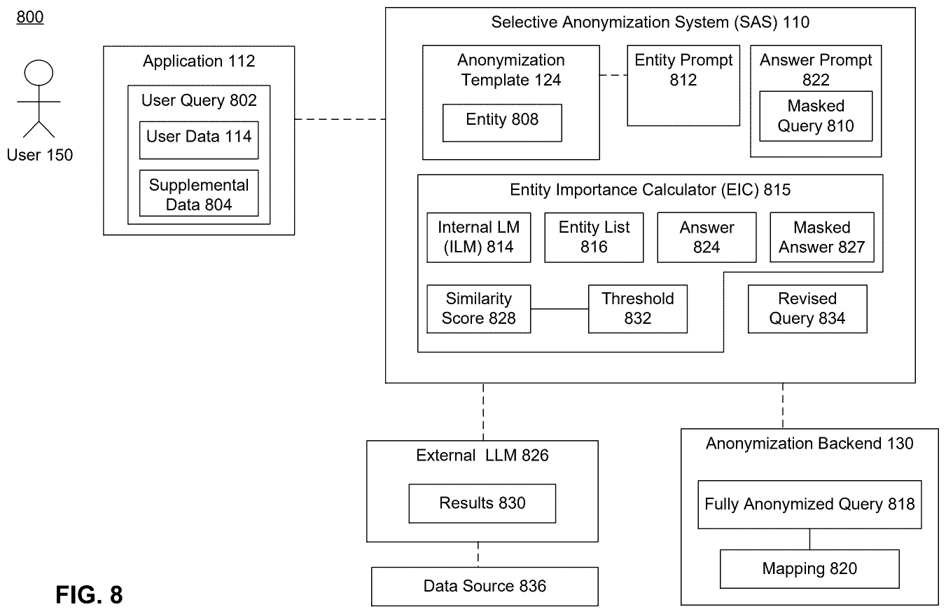

FIG. 8 is a block diagram 800 illustrating an example selective anonymization system (SAS) 110 with intelligent masking, according to some embodiments. FIG. 8 illustrates features that are similarly numbered and labeled to those described above, particularly with respect to FIG. 1, and may include similar properties and functionality to that described above, but may also represent different embodiments of those similarly numbered and labeled features.

User 150 may provide a user query 802 to an application 112. The user query 802 may be an instruction or command from user 150 requesting or updating information. In some embodiments, the user query 802 may be received through or otherwise related to or associated with the application 112. For example, application 112 may be a stock trading application and user query 802 may be related to the price or trading of stocks. In some embodiments, the application 112 may reject any user query 802 which is outside of its configuration to process. For example, a user query 802 about the weather may be rejected by the stock application.

In some embodiments, the application 112 may be configured to receive and process any type of queries without distinction (e.g., both stock and weather queries may be accepted). In some embodiments, the application 112 or SAS 110 may distinguish whether the user query 802 is related to the functionality of the application 112, or is a general query directed to some other topic or functionality. In some embodiments, this classification of the user query 802 as being an application-specific query or general query may be used to select a corresponding anonymization template 124 as is described in greater detail below.

The user query 802 may include both user data 114 and supplemental data 804. The user data 114 may include any text or data input as part of user query 802 that includes PII, confidential information, or potentially confidential or personal information. The supplemental data 804 may include all the other words or phrases provided in the query. For example, a user query 802 may be: “This is Dev, and I am leaving Mumbai on Feb. 21^{st} and landing in Berlin the morning of Feb. 22^{nd} at 8 am, what is the weather going to be when I land?” In this example, the user data 114 may include: Dev, Mumbai, Feb. 21^{st}, Berlin, morning, Feb. 22^{nd}, and 8 am. The supplemental data 804 may include the remaining words in the query which connect and/or give context to the user data 114.

In conventional processing, a query received from a user may be provided directly to an untrusted LLM, which may process the query and return a result. However, this creates security issues because it is not known if the data received as part of the query is going to be stored elsewhere and what this stored data may be used for beyond the query, or who will have access to the data. SAS 110 may anonymize or remove those portions of the user data 114 which are not necessary to answer the user query 802, thus minimizing the potential for security leaks, and data exposure to untrusted computing services.

Rather than allowing the user query 802 to be directly passed from the user 150 to an external LLM (large language model) 806, SAS 110 may perform initial processing on the user query 802 to anonymize or remove any sensitive or unnecessary user data 114. As described herein SAS 110 may identify and distinguish between which user data 114 is important for generating an accurate response to the query (which would be provided to the external LLM 826), and which user data 114 is unnecessary for generating an accurate response (and thus is removed from the query or otherwise masked from the external LLM 826).

One of the challenges with testing different words of user query 802 for importance (e.g., impact on an output) is this importance testing is an extremely resource intensive and time consuming process. While it is possible to test every word within the user query 802 for importance, this approach increases the amount of computing resources and time required to process a given query, limits the number of queries that can be processed, and reduces the availability of those resources to other system processes. One of the advantages of SAS 110 is that rather than testing the importance of every word in the user query 802, SAS 110 limits how much of the user query 802 is tested through the use of an entity 808, as described herein. This use of entities 808 by SAS 110 consumes far fewer computing resources and improves the overall speed of processing for any particular query 802 without any loss in accuracy of results.

In the context of performing importance testing, a word in a user query 802 may include any space-delimited string of one or more alphanumeric characters. By contrast, an entity 808, include a category of information that may include one or more words, referred to herein as user data 114. In some embodiments, user data 114 may include one or more words. A given user query 802 will have less user data 114 (corresponding to different entities 808), than it will words. In a simple example, entities 808 may include Name and Location. The user query 802 may include the request “Write a report on the average temperature in Dubai”. While a word-based testing system would indiscriminately test all nine different words in the user query 802 for importance, SAS 110 may identify that the user query 802 only includes one entity 808 (e.g., user data 114 corresponding to location), and thus would only test “Dubai” for importance. The remaining words in the user query 802 (Write, a, report, on, the, average, temperature, in) are supplemental data 804 and would not be tested for importance by SAS 110 because they do not relate to any entity 808.

SAS 110 identifies the user data 114 (which may include one or more words) within the user query 802 corresponding to an entity 808, and focuses on identifying which user data 114 is important to generating an accurate response to the query, and which user data 114 can be masked from the external LLM 826. If all the user data 114 is masked, then the external LLM 826 would not be able to understand and generate an accurate response to the user query 802. As such, SAS 110 may perform intelligent masking on that user data 114 which is not necessary for answering the user query 802 accurately.

In the example user query 802, provided above, which states: “This is Dev, and I am leaving Mumbai on Feb. 21^{st} and landing in Berlin the morning of Feb. 22^{nd} at 8 am, what is the weather going to be when I land?” The user data 114 may include: Dev, Mumbai, Feb. 21^{st}, Berlin, morning, Feb. 22^{nd}, and 8 am. Upon performing processing as described herein, SAS 110 may test the importance of the various user data 114, and mask the following user data: Dev, Mumbai, Feb. 21^{st}, while leaving the following user data unmasked: Berlin, morning, Feb. 22^{nd}, 8 am. An example of a revised query 834 which may be provided to external LLM 826 for processing may be: “This is XX1, and I am leaving XX2 on XX3 and landing in Berlin the morning of Feb. 22^{nd} at 8 am, what is the weather going to be when I land?”

In some embodiments, SAS 110 may retrieve or use an anonymization template 124 which includes one or more entities 808. An entity 808 may be a category of information that identifies user data 114 within the user query 802. Example entities 808 may include name, address, social security number, and phone number.

In some embodiments, a particular application 112 may include its own anonymization template 124 with its own likely to be used entities 808. For example, a stock trading application 112 may include an anonymization template 124 with the following example entities 808: ticker, price, company name, trading account, dollar amount. A different application 112, such as a travel booking application 112, may include its own anonymization template 124 different from the stock trading application. Example traveling booking entities may include: name, passport number, flight number, city, airport code, date, and time. Having unique anonymization templates 124 for different applications may minimize the number of entities 808 that need to be checked for each application 112, thus speeding up processing and using less computing resources. It would waste unnecessary resources to scan a travel related query for stock-ticker information, or to scan a stock-trading query for flight information, since the likelihood of this information being included in a user query 802 is very slim.

For simplicity, only a single application template 124 with a single entity 808 is illustrated, but it is understood that SAS 110 may utilize any number of application templates 124 with any number of entities 808. In some embodiments, each application 112 may have access to an application-specific anonymization template 124, and a general or global anonymization template 124. As indicated above—, if user query 802 is classified as a general query, SAS 110 may use the general or global anonymization template 124, instead of the default application-specific anonymization template 124. An example global anonymization template 124 may include entities 808 such as: name, social security number, location, date, time, price, telephone number, address. In some embodiments, each user query 802 may be checked against the global anonymization template 124, and any applicable application-specific anonymization template 124.

In some embodiments, SAS 110 may identify which user data 114 exists in user query 802 based on the use of one or more anonymization templates 124 (e.g., global anonymization template 124 and/or application-specific anonymization template). In some embodiments, SAS 110 may generate an entity prompt 812 which provides the anonymization template(s) 124 and user query 802 to an entity importance calculator (EIC) 815 to identify which user data 114 exists in user query 802. For example, EIC 815 may identify any information in the user query 802 that corresponds to a name, location, date, social security number, or other enumerated entity 808 in the provided anonymization template(s) 124.

As part of its operations, EIC 815 may utilize the functionality of an internal language model (ILM) 814. In some embodiments ILM 814 may include a language model that is used without access to an external data source 836. In some embodiments, ILM 814 may be connected to an internal data source, or may have no connection to any data source. As is discussed in greater detail below, the consistency of answers generated by the ILM 814 (e.g., such that the same inputs will produce the same outputs) is utilized by EIC 815, while the ‘correctness’ of the answer is ignored.

In some embodiments, EIC 815 may generate one or more prompts for ILM 814, including but not limited to an entity list prompt. In executing the entity list prompt, ILM 814 may generate and return an entity list 816 including one or more words or phrases of identified, entity-related user data 114 from user query 802, corresponding to the one or more entities 808.

In some embodiments, in lieu of using anonymization template 124 and entity prompt 812 to identify the user data 114, SAS 110 may rely on or use an anonymization backend 130. In some embodiments, the anonymization backend 130 may be a computing service that is configured to identify and mask all the user data 114 in user query 802. In some embodiments, the anonymization backend may generate and return both a fully anonymized query 818 and corresponding mappings 820.

The fully anonymized query 818 may include a version of the user query 802 in which each identified word or phrase of user data 114 is uniquely masked (e.g., replaced with a string of alphanumeric and/or symbolic characters), and the mapping 820 may include a table or other data structure indicating which unique masking corresponds to which user data 114. For example, user query 802 “I am landing in New York on March 31^{st}, what is the weather?”, may be processed and fully anonymized query 818 of “I am landing in AA1 on ABC, what is the weather?” may be returned, along with mapping 820: AA1=“New York”, ABC=“March 31^{st}”.

In some embodiments, once SAS 110 has identified the user data 114 (e.g., based on anonymization template 124 or anonymization backend 130), SAS 110 may generate one or more masked queries 810 for each occurrence of user data 114 in user query 802. In some embodiments, SAS 110 or EIC 815 may generate an answer prompt 822 including instructions to ILM 814 to execute both user query 802 and one or more masked queries 810. Each masked query 810 may include a variation of the user query 802 in which a different phrase of user data 114 is masked.

In the example above, in which the user query 802 is “I am landing in New York on March 31^{st}, what is the weather?”, SAS 110 may generate two masked queries 810: “I am landing in AA1 on March 31^{st}, what is the weather?” and “I am landing in New York on ABC, what is the weather?”. Answer prompt 822 may instruct ILM 814 to execute these three queries (one user query 802 and two masked queries 810) to generate answers (e.g., answer 824 to user query 802 and a unique masked answer 827 for each masked query 810). ILM 814 may execute the queries (user query 802 and masked queries 810) in accordance with answer prompt 822 and generate both an answer 824 and two masked answers 827 (e.g., corresponding to each masked query 810). For simplicity, only a single masked query 810 and masked answer 827 is illustrated, but it is understood there may be any number of masked queries 810 and corresponding masked answers 827.

One advantage to identifying the user data 114, based on the entities 808 of an anonymization template 124, is that only the importance of the user data 114 is checked for importance. In some embodiments, checking the importance of various phrases may consume additional processing time and resources, thus skipping the supplemental data 804 (which is not checked for importance), improves the processing time and throughput of the system, while maintaining security. In some embodiments, if SAS 110 does not detect any user data 114 in user query 802, then user query 802 may be passed directly to external LLM 826 for processing.

In some embodiments, SAS 110 may generate one or more similarity scores 828, each similarity score 828 indicating a similarity between answer 824 and a corresponding masked answer 827. In continuing the example, SAS 110 may generate two similarity scores, a first similarity score indicating a similarity between the first masked answer 827 and answer 824, and a second similarity score indicating a similarity between the second masked answer 827 and answer 824.

In some embodiments, the ‘correctness’ of the answer 824 and masked answer 827 in responding to the user query 802 may be irrelevant. SAS 110 may use the similarity score 828 to identify which user data 114 is important and should be provided to external LLM 826 or is unimportant can be masked from external LLM 826. Using an ILM 814 allows SAS 110 to identify and weight the importance of the various user data 114 without exposing the user data 114 to an external or untrusted source in external LLM 826. In some embodiments, ILM 814 may be configured to produce identical output or answers 824, 826 to identical input. Thus, if the same query is provided to ILM 814 twice, ILM 814 would produce the same answer twice.

In some embodiments, the higher the similarity score, the more similar the masked answer 827 is to the answer 824, thus the less important the masked user data 114 is to processing the user query 802, and thus the more likely the user data 114 is to be masked in the revised query 834. A high similarity score 828 may indicate that the user data 114 which has been masked in the corresponding masked query 810 is less important and a better candidate for masking. In some embodiments, SAS 110 may compare the similarity score 828 to a threshold 832. Any if the similarity score exceeds the threshold 832, then the corresponding user data 114 may be marked as being masked.

As noted above, based on the comparison of similarity score 828 to threshold 832, SAS 110 may generate a revised query 834. In generating the revised query 834, SAS 110 may either mask the important user data 114 from user query 802, or unmask the unimportant user data 114 from fully anonymized query 818 using mapping 820. Either process will produce the same revised query 834.

SAS 110 may provide the revised query 834, provide this to external LLM 826 for processing. External LLM 826 may execute the revised query 834 against a data source 836 (which may be unavailable to ILM 814) to generate results 830. The results 830 may then be provided back to SAS 110 or provided directly back to user 150 via application 112 or another electronic communication (e.g., email, text, pop-up, etc.).

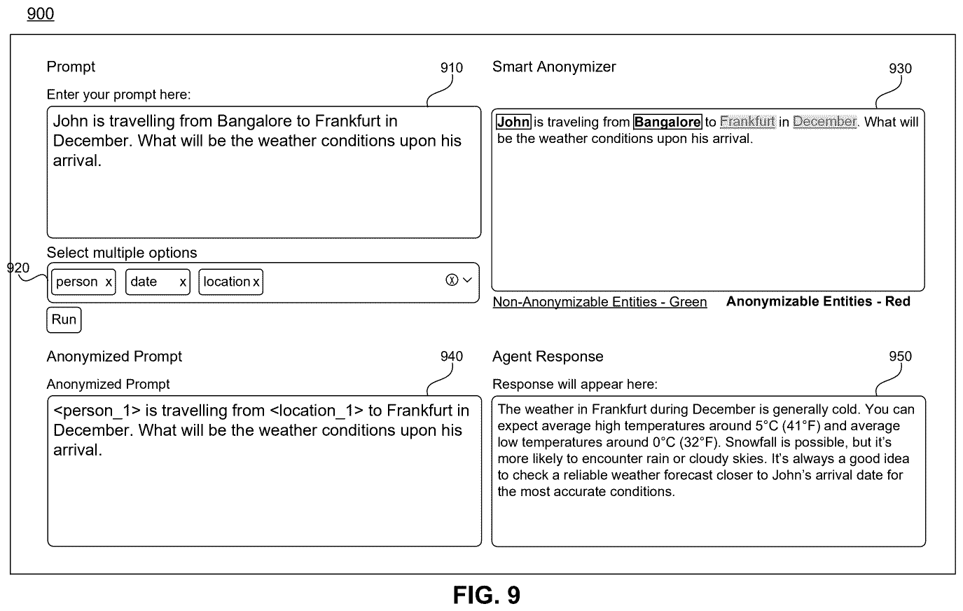

FIG. 9 is an example user interface 900 through which a user 150 may communicate with SAS 110, according to some embodiments. In box 910, the user 150 may enter a user query 802. Box 920 may display the entities 808 identified within or to be checked against the user query 802 of box 910. In some embodiments, the user 150 may have the option of adding new entities 808 (by typing them in) or removing existing entities 808 (by selecting the x).

Box 930 may illustrate the result of processing the query from box 910 against the entities of box 920. It may illustrate the important or non-anonymizable entities in underline and the unimportant or anonymizable entities in bold. In some embodiments, the important/unimportant entities 808 or user data 114 may be color coded. Box 940 may illustrate an example revised query 834, and box 950 may include the result 830 as generated by an external LLM 826.

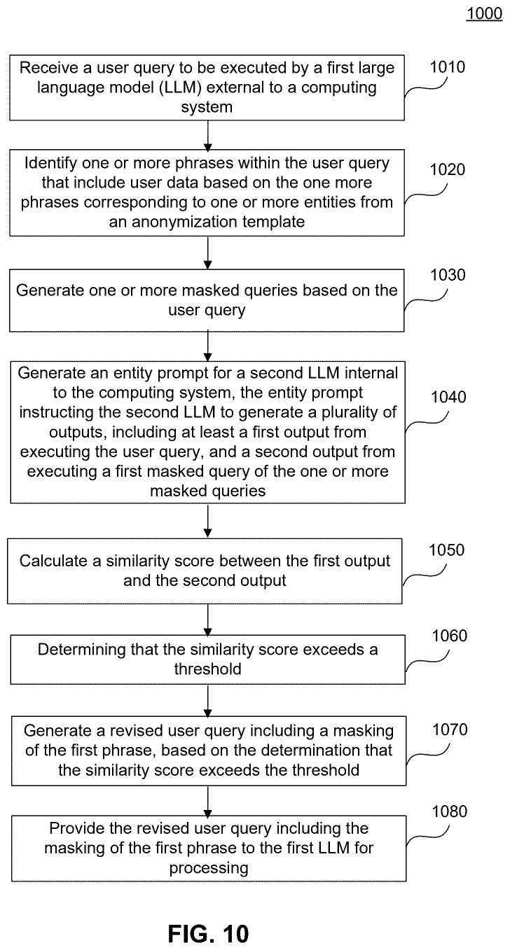

FIG. 10 is a flowchart 1000 illustrating example operations for providing an selective anonymization system (SAS) 110, according to some embodiments. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art. Method 1000 shall be described with reference to FIG. 8.

In 1010, a user query to be executed by a first large language model (LLM) external a the computing system is received. For example, SAS 110 may receive a user query 802, which is to be executed by external LLM 826. The external LLM 826 may include a publicly available LLM or other LLM hosted outside of the confines of a computing system or password protected network on which user 150 is operating a user device. In some embodiments, the external LLM 826 may be managed or created by a first organization, and the ILM 814 may be managed or created by a second organization. In some embodiments, a network administrator associated with an organization that employs user 150 may have authorization to managed what data sources are accessible to ILM 814, but not External LLM 826. In some embodiments, ILM 814 may include a small language model (e.g., relative to external LLM 826).

In 1020, one or more phrases are identified within the user query that include user data based on the one or more phrases corresponding to one or more entities from an anonymization template. For example, SAS 110 may identify an anonymization template 124 that corresponds to an application 112 through which user query 802 is received. In some embodiments, SAS 110 may receive user queries 802 from various users 150 operating different applications 112, each application 112 may have its own corresponding anonymization template 124 with its uniquely identified entities 808. In some embodiments, an application-specific anonymization template 124 may import a set of global entities from a global template 124, which may be applied to every user query 802, regardless of the application 112 from which the user query 802 is received. The entities 808 may include one or more categories of data, specific keywords, or phrases that are likely to be found in a user query 802 which may include or correspond to user data 114.

In 1030, one or more masked queries are generated based on the user query. For example, SAS 110 may generate one or more masked queries 810. In some embodiments, each masked query may include user query 802 with a phrase of user data 114 corresponding to an entity 808 of anonymization template 124 masked. Masking may include replacing a particular phrase of user data 114 in user query 802 with a generic variable or alphanumeric string.

In some embodiments, anonymization template 124 may indicate one or more entities 808 that are always masked, such as social security number. If an always-masked entity 808 is identified in user query 802, no masked query 810 may be generated for the user data 114 corresponding to the always-masked entity 808. This may speed up processing and system throughput. Further, revised query 834 will include a masking of the user data 114 corresponding to the always-masked entity 808.

In 1040, an entity prompt is generated for a second LLM internal to the computing system, the entity prompt instructing the second LLM to generate a plurality of outputs, including at least a first output from executing the user query, and a second output from executing a first masked query of the one or more masked queries. For example, SAS 110 or EIC 815 may generate entity prompt 812 instructing ILM 814 to generate answer 824 from executing user query 802, and one or more masked answer 827, each masked answer corresponding to a different masked query 810.

In 1050, a similarity score is calculated between the first output and the second output. For example, for each masked answer 827, SAS 110 may generate a similarity score 828 based on comparing a similarity of the masked answer 827 to answer 824. Any similarity score may be calculated, including but not limited to Cosine similarity.

In 1060, it is determined that the similarity score exceeds a threshold. For example, SAS 110 may compare each similarity score 828 to a threshold 832. If a similarity score 828 is greater than or equal to the threshold 832, this may indicate that the user data 114 that has been masked in the corresponding masked query 810 is a good candidate for masking in a revised query 834. If a similarity score 828 is less than the threshold 832, this may indicate that the user data 114 that has been masked in the corresponding masked query 810 is not to be masked in the revised query 834.

In 1070, a revised user query including a masking of the first phrase is generated based on the determination that the similarity score exceeds the threshold. For example, SAS 110 may generate the revised query 834 with the user data 114 corresponding to a masked query 810 for which a similarity score 828 for the masked answer 827 is greater than or equal to threshold 832. In some embodiments, the revised query 834 may be provided to external LLM 826 with a prompt, as generated by SAS 110, instructing external LLM 826 not to try and figure out what the masked information included in revised query 834 may be.

In 1080, the revised user query including the masking of the first phrase is provided to the first LLM for processing. For example, SAS 110 may provide the revised query 834 to external LLM 826 for processing. External LLM 826 may process and execute the revised query 834 against one or more data sources 836 (which may be unavailable or inaccessible to ILM 814) and generate and return a result 830. SAS 110 may then provide this result to user 150 via application 112 or other electronic messaging.

What is claimed is:

1. A computer-implemented method, comprising:
receiving, by at least one processor of a computing system, a user query to be executed by a first large language model (LLM) external to the computing system;
identifying one or more phrases within the user query that include user data based on the one or more phrases corresponding to one or more entities from an anonymization template;
generating one or more masked queries based on the user query, wherein each masked query comprises the user query with a first phrase of the one or more phrases masked;
generating an entity prompt for a second LLM internal to the computing system, the entity prompt instructing the second LLM to generate a plurality of outputs, including at least a first output from executing the user query, and a second output from executing a first masked query of the one or more masked queries;
calculating a similarity score between the first output and the second output;
determining that the similarity score exceeds a threshold;
generating a revised user query including a masking of the first phrase, based on the determination that the similarity score exceeds the threshold; and
providing the revised user query including the masking of the first phrase to the first LLM for processing, wherein the first LLM is configured to execute the revised user query and return a result to the revised user query.

2. The computer-implemented method of claim 1, wherein the second LLM is locally hosted by the computing system, and the first LLM is externally hosted by a different computing system.

3. The computer-implemented method of claim 2, wherein the first LLM accesses to an external data source inaccessible to the second LLM, wherein the revised user query is executed against the external data source.

4. The computer-implemented method of claim 1, wherein the similarity score comprises a cosine similarity between the first output and the second output.

5. The computer-implemented method of claim 1, wherein the identifying one or more phrases from within the user query that include user data comprises:
providing the user query to an anonymizer configured to identify and anonymize the user data in the user query;
receiving, from the anonymizer, an anonymized version of the user query, in which each of the one or more entities are anonymized; and
identifying the one or more phrases based on which portion of the anonymized version of the user query has been anonymized.

6. The computer-implemented method of claim 1, wherein the second LLM generates a third output based on executing a second masked query of the one or more masked queries, wherein the second masked query comprises the user query with a masking of a second phrase of the one or more phrases.

7. The computer-implemented method of claim 6, further comprising:
calculating a new similarity score between the first output and the third output;
determining that the new similarity score exceeds the threshold; and
masking the second phrase based on the determination that the new similarity score exceeds the threshold, wherein the revised user query includes both a masking of the first phrase and a masking of the second phrase.

8. The computer-implemented method of claim 1, wherein the second LLM is not connected to a data source against which to execute the user query and the one or more masked queries.

9. The computer-implemented method of claim 1, wherein the anonymization template is specific to a first application through which the user query was received, wherein a second application is associated with a second anonymization template.

10. A computing system comprising:
a memory; and
at least one processor coupled to the memory and configured to perform operations comprising:
receiving a user query to be executed by a first large language model (LLM) external to the computing system;
identifying one or more phrases within the user query that include user data based on the one or more phrases corresponding to one or more entities from an anonymization template;
generating one or more masked queries based on the user query, wherein each masked query comprises the user query with a first phrase of the one or more phrases masked;
generating an entity prompt for a second LLM internal to the computing system, the entity prompt instructing the second LLM to generate a plurality of outputs, including at least a first output from executing the user query, and a second output from executing a first masked query of the one or more masked queries;
calculating a similarity score between the first output and the second output;
determining that the similarity score exceeds a threshold;
generating a revised user query including a masking of the first phrase, based on the determination that the similarity score exceeds the threshold; and
providing the revised user query including the masking of the first phrase to the first LLM for processing, wherein the first LLM is configured to execute the revised user query and return a result to the revised user query.

11. The computing system of claim 10, wherein the second LLM is locally hosted by the computing system, and the first LLM is externally hosted by a different computing system.

12. The computing system of claim 11, wherein the first LLM accesses to an external data source inaccessible to the second LLM, wherein the revised user query is executed against the external data source.

13. The computing system of claim 10, wherein the similarity score comprises a cosine similarity between the first output and the second output.

14. The computing system of claim 10, wherein the identifying one or more phrases from within the user query that include user data comprises:
providing the user query to an anonymizer configured to identify and anonymize the user data in the user query;
receiving, from the anonymizer, an anonymized version of the user query, in which each of the one or more entities are anonymized; and
identifying the one or more phrases based on which portion of the anonymized version of the user query has been anonymized.

15. The computing system of claim 10, wherein the second LLM generates a third output based on executing a second masked query of the one or more masked queries, wherein the second masked query comprises the user query with a masking of a second phrase of the one or more phrases.

16. The computing system of claim 15, the operations further comprising:
calculating a new similarity score between the first output and the third output;
determining that the new similarity score exceeds the threshold; and
masking the second phrase based on the determination that the new similarity score exceeds the threshold, wherein the revised user query includes both a masking of the first phrase and a masking of the second phrase.

17. The computing system of claim 10, wherein the second LLM is not connected to a data source against which to execute the user query and the one or more masked queries.

18. The computing system of claim 10, wherein the anonymization template is specific to a first application through which the user query was received, wherein a second application is associated with a second anonymization template.

19. A non-transitory computer-readable medium having instructions stored thereon that, when executed by at least one computing device, cause the at least one computing device to perform operations comprising:
receiving, by at least one processor of a computing system, a user query to be executed by a first large language model (LLM) external to the computing system;
identifying one or more phrases within the user query that include user data based on the one or more phrases corresponding to one or more entities from an anonymization template;
generating one or more masked queries based on the user query, wherein each masked query comprises the user query with a first phrase of the one or more phrases masked;
generating an entity prompt for a second LLM internal to the computing system, the entity prompt instructing the second LLM to generate a plurality of outputs, including at least a first output from executing the user query, and a second output from executing a first masked query of the one or more masked queries;
calculating a similarity score between the first output and the second output;
determining that the similarity score exceeds a threshold;
generating a revised user query including a masking of the first phrase, based on the determination that the similarity score exceeds the threshold; and
providing the revised user query including the masking of the first phrase to the first LLM for processing, wherein the first LLM is configured to execute the revised user query and return a result to the revised user query.

20. The non-transitory computer-readable medium of claim 19, wherein the second LLM is locally hosted by the computing system, and the first LLM is externally hosted by a different computing system.
